(19) United States
(12) Patent Application Publication
(10) Pub. No.: US 2008/0127007 A1
(43) Pub. Date: May 29, 2008

(54) METHOD TO COMBINE ADDRESS ANONYMOUS HASH ARRAY WITH CLOCK, DATA PACK AND BIT ANONYMOUS ARRAYS TO GATHER DATA OF REGISTERS

(76) Inventor: Jen-Yeu Chen, Cedar Park, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/554,175

(22) Filed: Oct. 30, 2006

(51) Int. Cl. G06F 17/50

(52) U.S. Cl. 716/4; 703/16

(57) ABSTRACT

A method and system for combining address anonymous hash arrays with clock, datapack and bit anonymous arrays to gather data of registers is disclosed. The method includes receiving a set of process inputs and a set of user inputs associated with a target system and processing a set of user-requested system-interface connections associated with the target system. An anonymous hash array for direct and special register addresses associated with the target system is created, as are a clock group, a datapack anonymous array and a bits anonymous array for a specified receiving bus. Whether a selected register is a special register is then determined. In response to determining that the selected register is a special register, reference to the anonymous hash array is performed to obtain an address for the selected register. Attribute data for the selected register is obtained and attribute data for the selected register is monitored.

### BACKGROUND OF THE INVENTION

1. Technical Field

The present invention relates in general to data processing systems and in particular to array addressing. Still more particularly, the present invention relates to a system, method and computer program product for combining address anonymous hash arrays with clock, datapack and bit anonymous arrays to gather data of registers.

2. Description of the Related Art

Computer systems use registers to temporarily store small amounts of data. A register is a single line of data, which may be from 8 to 64 bits wide. There are two main categories of registers: direct and special. A direct register, as its name implies, is defined as a register whose contents can be directly accessed if a user (or application) knows which chip physically contains the register, which bus accesses that chip and the name of the register (e.g., the register's address). A direct register is further defined as a register having a fixed content format. That is, a direct register can be pre-formatted to contain only data, instructions, addresses, etc.

A special (indirect) register, however, is defined as a register whose parameters are initially undefined. That is, a special register must first be initialized with an address (or other means of location) for the register, a format describing what data is contained in which bit fields, what bus is to be used to access the register, which clock the special register will use, etc.

Unfortunately, slow and tedious addressing in indirect (or special) registers and direct registers increases the time spent in gathering important data related to registers. To obtain direct register data under the prior art, a great deal of identification data is required (e.g. chip type, register and bus information that is used to get the register address and then obtain the register data). Without using an address hash array, the process becomes exceedingly tedious and error-prone. To obtain indirect (special) register data and attribute values, the problem of usage is even more complex and tedious since, in addition to the information listed above, the clock group, data pack, bit and other miscellaneous information are required.

### SUMMARY OF THE INVENTION

In response to the issues addressed above, the present invention presents a method, system and computer program product for monitoring data in a special register that is being used to transmit data from a driver bus to a specified receiving bus. In a preferred embodiment, the method includes the steps of: obtaining a special register address, from an anonymous hash array, for a special register, wherein the anonymous hash array assigns an address to the special register based on a chip version level of a chip on which the special register is located, a chip name for the chip on which the special register is located, a special register name for the special register, and a bus name of a specified receiving bus that is used to access the special register; partitioning a bandwidth of a driver bus and the specified receiving bus into multiple clock groups, wherein each clock group contains multiple data packs, and where each data pack contains at least one bit; defining a data pack anonymous array that references the multiple data packs for a specified clock group from the multiple clock groups; defining a bit anonymous array that references a bit array that describes specified bits for a specified data pack of the specified clock group; dereferencing the data pack anonymous array to obtain the multiple data packs for any specified clock group; dereferencing the bit anonymous array to obtain the bit array that describes specified bits for the specified data pack of the specified clock group; defining an opcode anonymous array that references all opcodes for the special register, wherein the opcodes include multiple attributes on which software, which retrieves information from the special register, is focused; writing, to the special register, the specified clock group, the specified data pack, a specified bit and a specified opcode for the special register; reading, from the special register, the specified clock group, the specified data pack, the specified bit and the specified opcode for the special register; transmitting data from the driver bus to the specified receiving bus; and monitoring the special register for changes, caused by the transmitting of data from the driver bus to the specified receiving bus, to the specified clock group, the specified data pack, the specified bit and the specified opcode that are stored in the special register.

The method may also include the step of, prior to obtaining the special register address, and in response to determining that a register to be accessed is a direct register, referring to said anonymous hash array to determine a direct register address of said direct register. In one embodiment, the step of dereferencing the data pack anonymous array to obtain the multiple data packs is performed in a register process module that is part of a register verification environment located in a process register information program, wherein the process register information program processes information from the special register to associate all specified-clock-group-related data packs with the specified clock group. In another embodiment, the step of dereferencing the bit anonymous array to obtain specified bits is performed in a register process module that is part of a register verification environment located in a process register information program, wherein the process register information program processes information from the special register to associate bits for every data pack of a specified clock group.

The above, as well as additional purposes, features, and advantages of the present invention, will become apparent in the following detailed written description.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed descriptions of an illustrative embodiment when read in conjunction with the accompanying drawings, wherein:

FIG. 1 depicts a block diagram of a general-purpose data processing system with which the present invention of a method, system and computer program product for combining address anonymous hash arrays with clock, datapack and bit anonymous arrays to gather data of registers may be performed;

FIG. 2 illustrates a block diagram of a verification environment containing software components for combining address anonymous hash arrays with clock, datapack and bit anonymous arrays to gather data of registers in accordance with a preferred embodiment of the present invention; and

FIG. 3 is a high-level logical flowchart of a process for combining address anonymous hash arrays with clock, datapack and bit anonymous arrays to gather data of registers in accordance with a preferred embodiment of the present invention.

### DETAILED DESCRIPTION OF THE PREFERRED EMBODIMENT

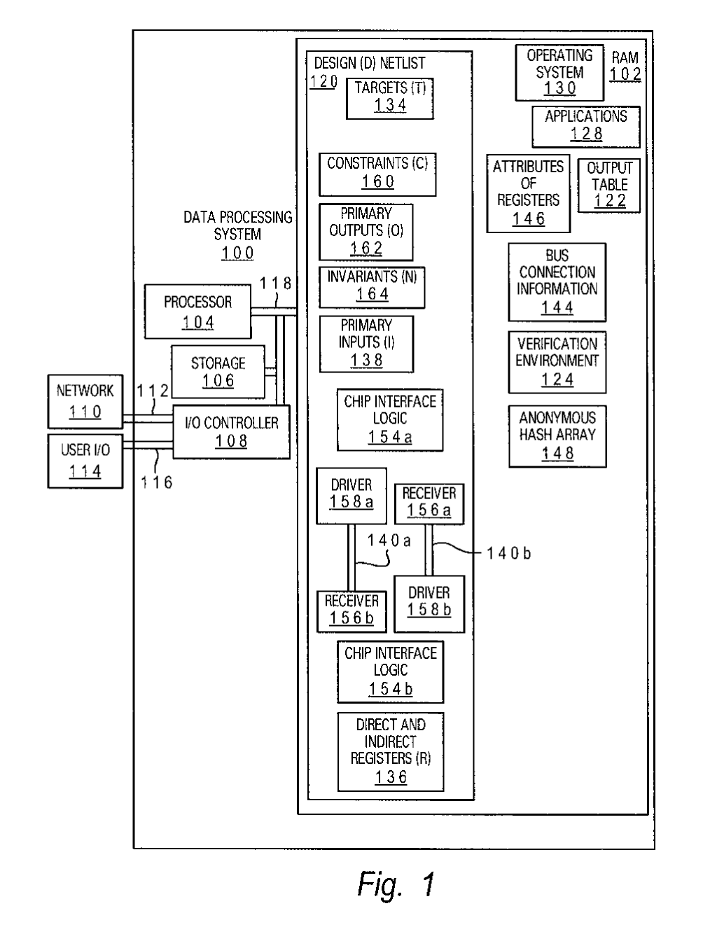

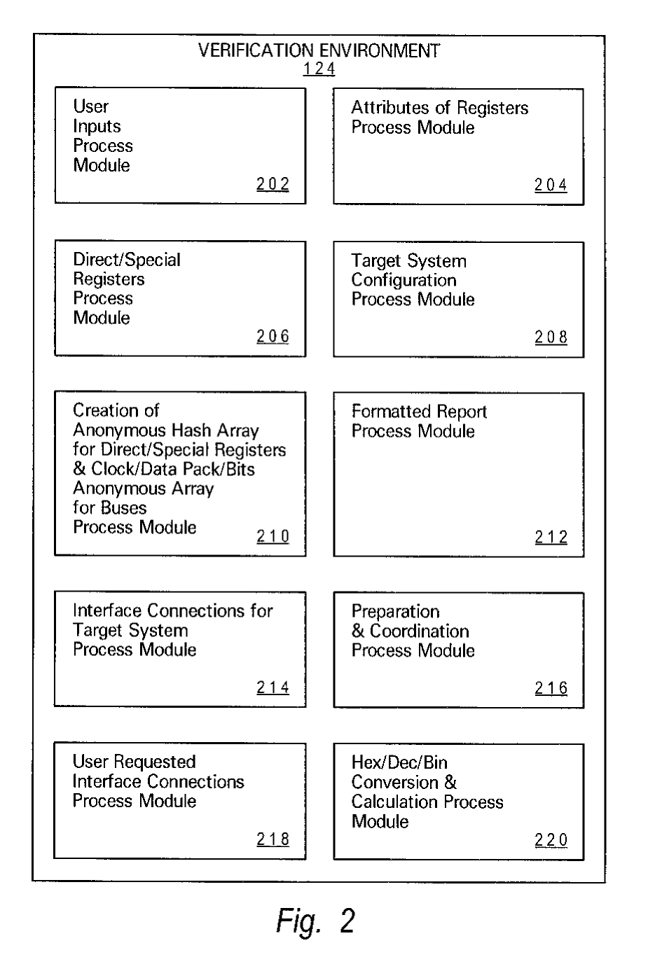

With reference now to the figures, and in particular with reference to FIG. 1, a block diagram of a general-purpose data processing system, in accordance with a preferred embodiment of the present invention, is depicted. Data processing system 100 contains a processing storage unit (e.g., RAM 102) and a processor 104. Data processing system 100 also includes non-volatile storage 106 such as a hard disk drive or other direct-access storage device. An Input/Output (I/O) controller 108 provides connectivity to a network 110 through a wired or wireless link, such as a network cable 112. I/O controller 108 also connects to user I/O devices 114 such as a keyboard, a display device, a mouse, or a printer through wired or wireless link 116, such as cables or a radio-frequency connection. System interconnect 118 connects processor 104, RAM 102, storage 106, and I/O controller 108.

Within RAM 102, data processing system 100 stores several items of data and instructions while operating in accordance with a preferred embodiment of the present invention. These include a design (D) netlist 120 and an output table 122 for interaction with a verification environment 124. In the embodiment shown in FIG. 1, initial design (D) netlist 120 contains constraints (C) 160, primary outputs (O) 162, invariants (N) 164, targets (T) 134 registers (R) 136 and primary inputs (I) 138. Other applications 128 and verification environment 124 interface with processor 104, RAM 102, I/O control 108, and storage 106 through operating system 130. One skilled in the data processing arts will quickly realize that additional components of data processing system 100 may be added to or substituted for those shown without departing from the scope of the present invention. Other data structures in RAM 102 include attributes of registers 146, anonymous hash array 148 and bus connection information 144.

A netlist, such as design (D) netlist 120, is a popular means for using a graph to compactly represent problems derived from circuit structures in the computer-aided design of digital circuits. Design (D1) netlist 120 contains a non-canonical representation of circuit components and offers the ability to analyze a function from the nodes in the graph. Design (D1) netlist 120 contains a directed graph with vertices representing gates and edges representing interconnections between those gates. The gates have associated functions, such as constants, primary inputs (I) 138 (e.g. RANDOM gates, which deliver random values at the given input), combinational logic (e.g., AND gates), and sequential elements (hereafter referred to as registers (R) 136).

Note that registers 136 include both direct registers and indirect (special) registers, as defined above.

All registers (R) 136 have two associated components: their next-state functions and their initial-value functions, which are represented as other gates in the figure. Certain gates in the netlist may be labeled as primary outputs (O) 162, invariants (N) 164, targets (T) 134, drivers 158a-158b, receivers 156a-156b, chip interface logic 154a-154b, and constraints (C) 160.

Semantically, for a given register (R) 136, the value appearing at its initial-value gate at time “0” (“initialization” or “reset” time) will be applied by verification environment 124 as the value of the register (R) 136 itself, the value appearing at its next-state function gate at time “i” will be applied to the register itself at time “i+1”. Certain gates are labeled as targets (T) 134 or constraints (C) 160. Targets (T) 134 correlate to the properties that require verification. Constraints (C) 160 are used to artificially limit the stimulus that can be applied to the RANDOM gates of design (D) netlist 120; in particular, when searching for a way to drive a “1” to a target (T) 134, verification environment 124 must adhere to rules such as, for purpose of example, that “every constraint gate must evaluate to a logical 1 for every time-step” or “every constraint gate must evaluate to a logical 1 for every time-step up to, and including, the time-step at which the target is asserted.” For example, in verification environment 124, a constraint (C) 160 could be added which drives a 1 exactly when a vector of RANDOM gates appears, to simulate even parity. Without constraints (C) 160, verification environment 124 would consider valuations with even or odd parity to those RANDOM gates; with constraints (C) 160, only even parity would be explored.

Invariants (N) 164 are similar to constraints in the sense that they will always evaluate to a “1”. However, unlike constraints (C) 160, they will naturally evaluate to a 1 even if discarded from the problem formulation (i.e., they are redundant facts about the way the design will behave due to its structural definition). These redundant facts may be useful in formal verification to obtain proofs of correctness. For example, an invariant (N) 164 node could assert that a set of registers (R) 136 always evaluates to even parity; that fact may help the performance of proof-based techniques.

Note that this netlist format allows for non-constant initial values. For example, assume that initial design (D1) netlist 120 has three “switch” registers (R) 136 (e.g. R1, R2, R3) in the design, which are nondeterministically initialized to “000”, “001”, “010”, “011”, “100”, “101”, and “110” (i.e., to all values other than “111”). This initialization can be specified by giving R1 and R2 unique “inputs” I1 and I2 (which are not primary inputs 138) as initial values, and defining the initial value of R3 as the value of a unique input (I3 AND NOT (I1 AND 12)). In other words, all cross-products of initial values of R1, R2 and R3 are possible, except that when “(I1 AND I2)=1”, verification environment 124 will disallow R3 from initializing to 1. Note that, in some embodiments, verification environment 124 may synthesize such logic automatically given the set of values to be produced at the initial value gates, which in some embodiments may be implemented by mapping the values to be produced as the “range” of a relation into a binary decision diagram, then into gates.

Processor 104 executes instructions from programs, often stored in RAM 102, in the course of performing the present invention. In a preferred embodiment of the present invention, processor 104 executes verification environment 124. The present invention focuses on chip interface logic 154a-154b to ensure that signals from drivers 158a-158b to receivers 156a-156b are properly propagated. That said, the method for combining address anonymous hash arrays with clock, datapack and bit anonymous arrays to gather data of registers of the present invention can be applied to a variety of interfaces and configurations, other than that shown in the preferred embodiment, without departing from the scope and intent of the present invention.

Referring now to FIG. 2, a block diagram of a verification environment containing software components for combining address anonymous hash arrays with clock, datapack and bit anonymous arrays to gather data of registers in accordance with a preferred embodiment of the present invention is illustrated. In a preferred embodiment of the present invention, verification environment contains a user inputs process module 202, an attributes of registers process module 204, a direct and special registers process module 206, a target system configuration process module 208, a creation of anonymous hash array for direct and special registers and clock, datapack and bit anonymous array for buses process module 210, a formatted report process module 212, an interface connections for target system process module 214, a preparation and coordination process module 216, a user-requested interface connections process module 218, and a hexadecimal, binary, and decimal conversion and calculation process module 220.

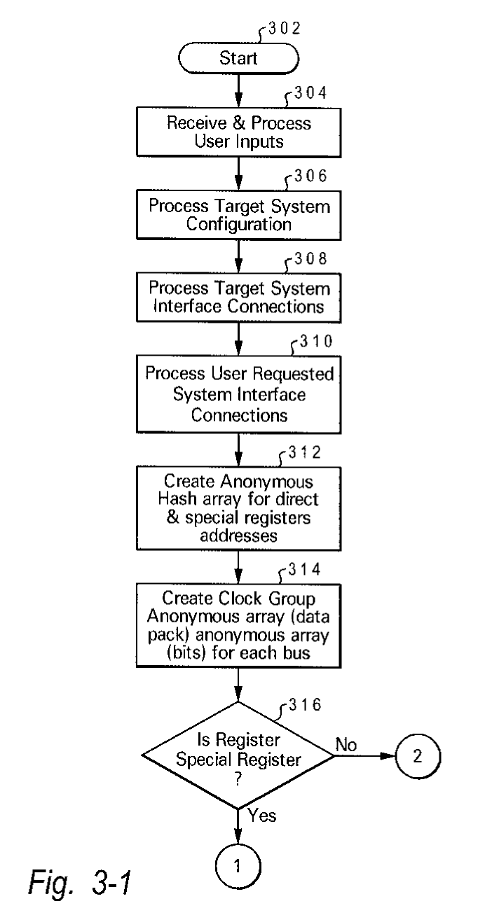

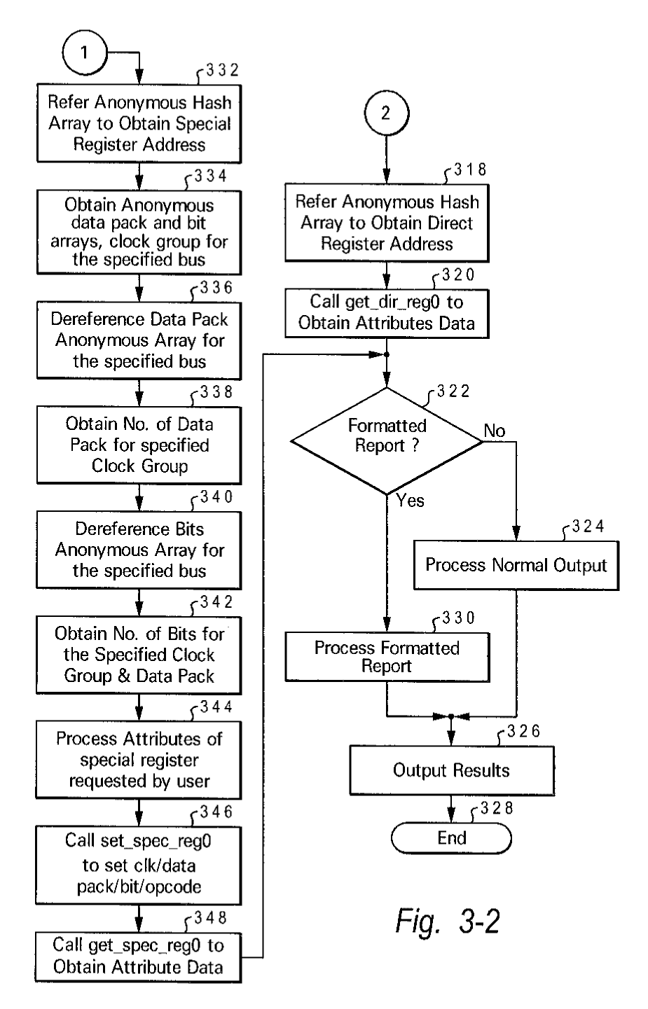

Turning now to FIG. 3, a high-level logical flowchart of a process for combining address anonymous hash arrays with clock, datapack and bit anonymous arrays to gather data of registers is depicted. The process starts at step 302 and then proceeds to step 304, which depicts verification environment 124 receiving process inputs, such as design (D) netlist 120 and user inputs across user I/O 114 and user inputs process module 202. That is, the user defines and inputs how special and direct registers are to be set up. This set-up includes, but is not limited to, the following issues. 1) To which bus is a register to be connected. In a computer system, there may be many real or virtual busses. The user can determine which pathway (bus) is to be used to access the register. 2) How many data sets can a register hold? Within each register, multiple data sets can be held. That is, assume that the register holds 64 bits. The user then defines the register as holding a certain number of data sets. For example, if the user defines the register as holding four data sets, then bits 0-3 could be for a first data set, bits 4-20 for second data set, bits 21-50 for a third data set, and bits 52-63 for the fourth data set. 3) What type of report regarding the system is required. That is, the user can set a flag (“1”) in the register indicating that a default (normal) report is to be generated, based on information read from the register, or the flag (“0”) can indicate that a user-defined formatted report is to be used.

The process next moves to step 306. Step 306 illustrates target system configuration processing module 208 determining the target system configuration embodied by design (D) netlist 120. In this step, information about the system, including which chips are in the system, is determined. The process then proceeds to step 308, which depicts interface connections for target systems process module 214 processing target systems for interface connections of design (D) netlist 120. For example, a public function (software object) can be called, which allows the user to identify how chips (nodes) in the computer system are to be connected (using which specific busses).

The process next moves to step 310, which illustrates user-requested interface connections process module 218 processing interface connections requested by a user across user I/O 114. That is, the user selects which bus is to be utilized. The process then proceeds to step 312, which depicts creation of anonymous hash array for direct and special registers and clock, datapack and bit anonymous array for buses process module 210 creating an anonymous hash array for direct register addresses and special register address. In step 312, actual names for direct and special registers, the data pack, and bit data sets are assigned using the anonymous has array. Also in step 312, the addresses for each direct and special register are created/assigned.

The process next moves to step 314, which illustrates the creation of an anonymous array for direct and special registers and clock, datapack and bit anonymous array for buses process module 210 creating a clock group, a datapack anonymous array and a bits anonymous array for each bus. Thus, in this step, each special register is assigned a particular clock, a data path (for accessing the special register), information about which bits describe which data sets (previously determined in step 304) through the creation and use of an anonymous array.

The process then proceeds to step 316, which depicts direct and special registers process module 206 determining whether a selected register is a special register. If direct and special registers process module 206 determines that the selected register is not a special register, then the process moves to step 318. Step 318 depicts attributes of registers process module 204 referring to anonymous hash array 148 to obtain a direct register address. This step can be accomplished through an embodiment of the following pseudocode:

$address=$regaddr_ref->{$ddl} {$chip} {$dir_reg} {$bus}

### Where $dir_reg: direct register, as noted below

The process then proceeds to step 320, which illustrates attributes of registers process module 204 performing a “get_dir_reg( )” call to obtain attribute data. This step can be accomplished through an embodiment of the following pseudocode:

get_dir_reg($chip, $addr, $cage, $node, $pos)

### Where get_dir_reg( . . . ) is a function used to get direct register data

The process next moves to step 322. Step 322 depicts formatted report process module 212 determining whether a formatted report is needed. If formatted report process module 212 determines that a formatted report is not needed, then the process proceeds to step 324, which depicts formatted report process module 212 processing normal output for delivery to output table 122. The process next moves to step 326. Step 326 illustrates formatted report process module 212 performing output of results to output table 122. The process then ends at step 328.

Returning to step 322, if formatted report process module 212 determines that a formatted report is needed, then the process proceeds to step 330, which depicts formatted report process module 212 generating a formatted report for delivery to output table 122. The process next moves to step 326, which is described above.

Returning to step 316, if direct and special registers process module 206 determines that the selected register is a special register, then the process moves to step 332. Step 332 depicts attributes of registers process module 204 referring to anonymous hash array 148 to obtain a special register address. This step can be accomplished through an embodiment of the following pseudocode:

```
$address = $regaddr-ref->{$ddl} {$chip} {$spec_reg} {$bus}
  Where $address: special register address, $ddl: version level, $chip: chip type
  $spec_reg: special register, $bus: bus name, $regaddr-ref: anonymous hash array
using direct/special register anonymous hash array form:
  Where
  $regaddr_ref⁼
  {dd1=>{chipl=>{regl=>{bus11=>bus_addr1111,bus12=>bus_addr1112,...,bus1m=>bus_addr111m},
              reg2=>{bus21=>bus_addr1121,bus22=>bus_addr1122,..,bus2m=>bus_addr112m},
                ................................................................................................
            regn=>{busn1=>bus_addr11n1,busn2=>bus_addr11n2,...,busnm=>bus_addr11nm}},
        chip2=>{reg1=>{bus11=>bus_addr1211,bus12=>bus_addr1212,..bus1m=>bus_addr121m},
        reg2=>{bus21=>bus_addr1221,bus22=>bus_addr1222,...,bus2m=>bus_addr122m},
          ..............................................................................................
        regn=>{busn1=>bus_addr12n1,busn2=>bus_addr12n2,...,busnm=>bus_addr12nm}},
      ..........................................................................................................
    chipq=>{reg1=>{bus11=>bus_addr1q11,bus12=>bus_addr1q12,...,bus1m=>bus_addr1q1m},
            reg2=>{bus21=>bus_addr1q21,bus22=>bus_adddr1q22,...,bus2m=>bus_addr1q2m},
              ................................................................................................
          regn=>{busn1=>bus_addr1nn1,busn2=>bus_addr1qn2,...,busnm=>bus_addr1qnm}}},
dd2=>{chip1=>{reg1=>{bus11=>bus_addr2111,bus12=>bus_addr2112,...,bus1m=>bus_addr211m},
            reg2=>{bus21=>bus_addr2121,bus22=>bus_addr2122,...,bus2m=>bus_addr212m},
              .................................................................................................
        regn=>{busn1=>bus_addr21n1,busn2=>bus_addr21n2,...,busnm=>bus_addr2nm}},
  chip2=>{reg1=>{bus11=>bus_addr2211,bus12=>bus_addr2212,...,bus1m=>bus_addr221m},
          reg2=>{bus21=>bus_addr2221,bus22=>bus_addr2222,...,bus2m=>bus_addr222m},
              ...............................................................................................
        regn=> {busn1=>bus_addr22n1,busn2=>bus_addr22n2,...,busnm=>bus_addr22nm}},
    .................................................................................................................
  chipq=>{reg1=>{bus11=>bus_addr2q11,bus12=>bus_addr2q12,...,bus1m=>bus_addr2q1m},
          reg2=>{bus21=>bus_addr2q21,bus22=>bus_addr2q22,...,bus2m=>bus_addr2q2m},
              ...................................................................................................
        regn=>{busn1=>bus_addr2qn1,busn2=>bus_addr2qn2,...,busnm=>bus_addr2qnm}}},
.......................................................................................................................
ddk=>{chip1=>{reg1=>{bus11=>bus_addrk111,bus12=>bus_addrk112,...,bus1m=>bus_addrk11m},
          reg2=>{bus21=>bus_addrk121,bus22=>bus_addrk122,...,bus2m=>bus_addrk12m},
              ................................................................................................
            regn=>{busn1=>bus_addrk1n1,busn2=>bus_addrk1n2,...,busnm=>bus_addrk1nm}},
  chip2=>{reg1=>{bus11=>bus_addrk211,bus12=>bus_addrk212,...,bus1m=>bus_addr211m},
            reg2=>{bus21=>bus_addrk221,bus22=>bus_addrk222,....,bus2m=>bus_addrk22m},
              ................................................................................................
        regn=>{busn1=>bus_addrk2n1,busn2=>bus_addrk2n2,...,busnm=>bus_addrk2nm}},
    ................................................................................................................
  chipq=>{reg1=>{bus11=>bus_addrkq11,bus12=>bus_addrkq12,...,bus1m=>bus_addrkq1m},
            reg2=>(bus2l=>bus_addrkq21,bus22=>bus_addrkq22,...,bus2m=>bus_addrkq2m},
              ................................................................................................
          regn=>{busn1=>bus_addrkqn1,busn2=>bus_addrkqn2,...,busnm=>bus_kqnm}}}}
Assume: dd level: k, chips: q, registers: n, buses: m
```

The process then proceeds to step 334, which illustrates attributes of registers process module 204 obtaining anonymous data pack and bit arrays, and a clock group for a specified receiving bus (e.g. $no_clk=3, $ref_data_pack=[3,2,4], $ref_bit=[[1,2,1][3,5,][2,4,6,8]]). In this example, the string provided shows that there are 3 clock groups for the bus, there are 3, 2, & 4 data packs for these three clock groups. There are 1, 2, and 1 bits for the first three data packs, 3 and 5 bits for the next two data packs, and 2, 4, 6, and 8 bits for the last four data packs. The process then proceeds to step 336, which illustrates attributes of registers process module 204 dereferencing a data pack anonymous array for the specified receiving bus. This step can be accomplished through an embodiment of the following pseudocode:

```
@data_pack = @$ref_data_pack
  Where @data_pack: deferenced anonymous data pack array,
  $ref data_pack:
  anonymous data pack array for the specified receiving bus
```

The process next moves to step 338. Step 338 depicts attributes of registers process module 204 obtaining an identifying number of a data pack for a specified clock group. This step can be accomplished through an embodiment of the following pseudocode:

```
$data_pack_no= $data_pack[$clk]
  Where $data_pack[$clk]: ref. to number of data packs for the specified
  clock group,
  $clk: specified clock group
```

The process then proceeds to step 340, which illustrates attributes of registers process module 204 dereferencing bits of an anonymous array for the specified receiving bus. (Dereferencing bits is accomplished by yielding a current value for the bits from a referenced array. That is, dereferencing is defined as the process of obtaining data from a referenced location, including the location of an array.) This step can be accomplished through an embodiment of the following pseudocode:

```
@bits = @$ref_bit
  Where @bits: deferenced anonymous bit array, $ref_bit: anonymous
  bit array for
  the specified receiving bus
```

The process next moves to step 342. Step 342 depicts attributes of registers process module 204 obtaining a number of bits for the specified clock group and data pack. This step can be accomplished through an embodiment of the following pseudocode:

```
$bit_no = $bits[$clk][$dp]
  Where $bit_no: number of bits for a specified clock group & specified
  data pack
  $clk: specified clock group, $clk: specified data pack
```

The process then proceeds to step 344, which illustrates attributes of registers process module 204 processing attributes of the special register requested by the user. This step can be accomplished through an embodiment of the following pseudocode:

```
@attr_list = @$regatrb {$chip} {$reg} {$rw} {$opcode} {attr}
  Where $regatrb: anonymous attribute hash array, @attr_list:
  dereference anonymous hash array, $chip: chip type, $rw: read/write
  option, $opcode: each opcode includes a set of attributes
```

The process next moves to step 346. Step 346 depicts attributes of registers process module 204 performing a call to a set_spec_reg( ) routine to set a clock, datapack, and bit opcodes. This step can be accomplished through an embodiment of the following pseudocode:

```
set_spec_reg($chip, $addr, $cage, $node, $node, $pos, $write_value)
  Where set_spec_reg(...): function used to write required info to the
  special register followed by get_spec_reg(...) to obtained the required
  register data, $chip: chip type, $addr: register address, $cage: related
  with bus connection, $node: related bus connection, $pos: related with
  bus connection, $write value: data processed and derived from clock
  group, data pack, bits, and opcode
```

The process then proceeds to step 348, which illustrates depicts attributes of registers process module 204 performing a call to a get_spec_reg( ) routine to obtain attributes data. This step can be accomplished through an embodiment of the following pseudocode:

```
get_spec_reg($chip, $addr, $cage, $node, $pos)
  Where get_spec_reg(...): function used to get the register data,
  has to pair with set_spec_reg(...)
```

The process then returns to step 322, which is described above.

The present invention thus provides a method, system, and computer program product for combining address anonymous hash arrays with clock, datapack and bit anonymous arrays to gather data of registers. The present invention provides easier access to attribute information for registers through the combination of a hash anonymous array with an address register, which can be used gather direct register information. With the combination of the hash array data and data from clock, datapack, or bit array, slow control bus information can be easily retrieved. With an anonymous hash array, direct register data can be easily retrieved. With the combination of an anonymous hash array and anonymous arrays, the attribute values of indirect (special) registers can be easily retrieved.

The present invention allows software to easily address any or all register information desired by the user during system bring-up or design validation. Because a system may have hundreds or even thousands of combinations of chip level, chip type, register, bus, clock group, data pack, and bit, the present situation provides an easy solution to a problem of tremendous complexity in addressing. Furthermore, with this solution, speed of information retrieval is enhanced and errors are prevented.

As described herein, the present invention thus provides for a method, system, and computer-readable medium for monitoring data in a special register that is being used to transmit data from a driver bus to a specified receiving bus. In a preferred embodiment, the method includes the steps of: obtaining a special register address, from an anonymous hash array, for a special register, wherein the anonymous hash array assigns an address to the special register based on a chip version level of a chip on which the special register is located, a chip name for the chip on which the special register is located, a special register name for the special register, and a bus name of a specified receiving bus that is used to access the special register; partitioning a bandwidth of a driver bus and the specified receiving bus into multiple clock groups, wherein each clock group contains multiple data packs, and where each data pack contains at least one bit; defining a data pack anonymous array that references the multiple data packs for a specified clock group from the multiple clock groups; defining a bit anonymous array that references a bit array that describes specified bits for a specified data pack of the specified clock group; dereferencing the data pack anonymous array to obtain the multiple data packs for any specified clock group; dereferencing the bit anonymous array to obtain the bit array that describes specified bits for the specified data pack of the specified clock group; defining an opcode anonymous array that references all opcodes for the special register, wherein the opcodes include multiple attributes on which software, which retrieves information from the special register, is focused; writing, to the special register, the specified clock group, the specified data pack, a specified bit and a specified opcode for the special register; reading, from the special register, the specified clock group, the specified data pack, the specified bit and the specified opcode for the special register; transmitting data from the driver bus to the specified receiving bus; and monitoring the special register for changes, caused by the transmitting of data from the driver bus to the specified receiving bus, to the specified clock group, the specified data pack, the specified bit and the specified opcode that are stored in the special register. The method may also include the step of, prior to obtaining the special register address, and in response to determining that a register to be accessed is a direct register, referring to said anonymous hash array to determine a direct register address of said direct register. In one embodiment, the step of dereferencing the data pack anonymous array to obtain the multiple data packs is performed in a register process module that is part of a register verification environment located in a process register information program, wherein the process register information program processes information from the special register to associate all specified-clock-group-related data packs with the specified clock group. In another embodiment, the step of dereferencing the bit anonymous array to obtain specified bits is performed in a register process module that is part of a register verification environment located in a process register information program, wherein the process register information program processes information from the special register to associate bits for every data pack of a specified clock group.

While the invention has been particularly shown as described with reference to a preferred embodiment, it will be understood by those skilled in the art that various changes in form and detail may be made therein without departing from the spirit and scope of the invention. It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communication links.

What is claimed is:

1. A method for monitoring data in a special register that is being used to transmit data from a driver bus to a specified receiving bus, the method comprising:
obtaining a special register address, from an anonymous hash array, for a special register, wherein the anonymous hash array assigns an address to the special register based on a chip version level of a chip on which the special register is located, a chip name for the chip on which the special register is located, a special register name for the special register, and a bus name of a specified receiving bus that is used to access the special register;
partitioning a bandwidth of the driver bus and the specified receiving bus into multiple clock groups, wherein each clock group contains multiple data packs, and where each data pack contains at least one bit;
defining a data pack anonymous array that references the multiple data packs for a specified clock group from the multiple clock groups;
defining a bit anonymous array that references a bit array that describes specified bits for a specified data pack of the specified clock group;
dereferencing the data pack anonymous array to obtain the multiple data packs for any specified clock group;
dereferencing the bit anonymous array to obtain the bit array that describes specified bits for the specified data pack of the specified clock group;
defining an opcode anonymous array that references all opcodes for the special register, wherein the opcodes include multiple attributes on which software, which retrieves information from the special register, is focused;
writing, to the special register, the specified clock group, the specified data pack, a specified bit and a specified opcode for the special register;
reading, from the special register, the specified clock group, the specified data pack, the specified bit and the specified opcode for the special register;
transmitting data from the driver bus to the specified receiving bus; and
monitoring the special register for changes, caused by the transmitting of data from the driver bus to the specified receiving bus, to the specified clock group, the specified data pack, the specified bit and the specified opcode that are stored in the special register.

2. The method of claim 1, wherein the method further comprises:
prior to obtaining the special register address, and in response to determining that a register to be accessed is a direct register, referring to said anonymous hash array to determine a direct register address of said direct register.

3. The method of claim 1, wherein the step of dereferencing the data pack anonymous array to obtain the multiple data packs is performed in a register process module that is part of a register verification environment located in a process register information program, wherein the process register information program processes information from the special register to associate all specified-clock-group-related data packs with the specified clock group.

4. The method of claim 1, wherein the step of dereferencing the bit anonymous array to obtain specified bits is performed in a register process module that is part of a register verification environment located in a process register information program, wherein the process register information program processes information from the special register to associate bits for every data pack of a specified clock group.

5. A system comprising:
a processor;
a data bus coupled to the processor;
a memory coupled to the data bus; and
a computer-usable medium embodying computer program code, the computer program code comprising instructions executable by the processor and configured for:
obtaining a special register address, from an anonymous hash array, for a special register, wherein the anonymous hash array assigns an address to the special register based on a chip version level of a chip on which the special register is located, a chip name for the chip on which the special register is located, a special register name for the special register, and a bus name of a specified receiving bus that is used to access the special register;
partitioning a bandwidth of a driver bus and the specified receiving bus into multiple clock groups, wherein each clock group contains multiple data packs, and where each data pack contains at least one bit;
defining a data pack anonymous array that references the multiple data packs for a specified clock group from the multiple clock groups;
defining a bit anonymous array that references a bit array that describes specified bits for a specified data pack of the specified clock group;
dereferencing the data pack anonymous array to obtain the multiple data packs for any specified clock group;
dereferencing the bit anonymous array to obtain the bit array that describes specified bits for the specified data pack of the specified clock group;
defining an opcode anonymous array that references all opcodes for the special register, wherein the opcodes include multiple attributes on which software, which retrieves information from the special register, is focused;
writing, to the special register, the specified clock group, the specified data pack, a specified bit and a specified opcode for the special register;
reading, from the special register, the specified clock group, the specified data pack, the specified bit and the specified opcode for the special register;
transmitting data from the driver bus to the specified receiving bus; and
monitoring the special register for changes, caused by the transmitting of data from the driver bus to the specified receiving bus, to the specified clock group, the specified data pack, the specified bit and the specified opcode that are stored in the special register.

6. The system of claim 5, wherein the instructions are further configured for:
prior to obtaining the special register address, and in response to determining that a register to be accessed is a direct register, referring to said anonymous hash array to determine a direct register address of said direct register.

7. The system of claim 5, wherein the instructions for dereferencing the data pack anonymous array to obtain the multiple data packs are further configured to be performed in a register process module that is part of a register verification environment located in a process register information program, wherein the process register information program processes information from the special register to associate all specified-clock-group-related data packs with the specified clock group.

8. The system of claim 5, wherein the instructions for dereferencing the bit anonymous array to obtain specified bits are further configured to be performed in a register process module that is part of a register verification environment located in a process register information program, wherein the process register information program processes information from the special register to associate bits for every data pack of a specified clock group.

9. A computer-readable medium embodying computer program code for monitoring data in a special register that is being used to transmit data from a driver bus to a specified receiving bus, the computer program code comprising computer executable instructions configured for:
obtaining a special register address, from an anonymous hash array, for a special register, wherein the anonymous hash array assigns an address to the special register based on a chip version level of a chip on which the special register is located, a chip name for the chip on which the special register is located, a special register name for the special register, and a bus name of a specified receiving bus that is used to access the special register;
partitioning a bandwidth of the driver bus and the specified receiving bus into multiple clock groups, wherein each clock group contains multiple data packs, and where each data pack contains at least one bit;
defining a data pack anonymous array that references the multiple data packs for a specified clock group from the multiple clock groups;
defining a bit anonymous array that references a bit array that describes specified bits for a specified data pack of the specified clock group;
dereferencing the data pack anonymous array to obtain the multiple data packs for any specified clock group;
dereferencing the bit anonymous array to obtain the bit array that describes specified bits for the specified data pack of the specified clock group;
defining an opcode anonymous array that references all opcodes for the special register, wherein the opcodes include multiple attributes on which software, which retrieves information from the special register, is focused;
writing, to the special register, the specified clock group, the specified data pack, a specified bit and a specified opcode for the special register;
reading, from the special register, the specified clock group, the specified data pack, the specified bit and the specified opcode for the special register;
transmitting data from the driver bus to the specified receiving bus; and
monitoring the special register for changes, caused by the transmitting of data from the driver bus to the specified receiving bus, to the specified clock group, the specified data pack, the specified bit and the specified opcode that are stored in the special register.

10. The computer-readable medium of claim 9, wherein the computer executable instructions are further configured for:
prior to obtaining the special register address, and in response to determining that a register to be accessed is a direct register, referring to said anonymous hash array to determine a direct register address of said direct register.

11. The computer-readable medium of claim 9, wherein the computer executable instructions for dereferencing the data pack anonymous array to obtain the multiple data packs are further configured to be performed in a register process module that is part of a register verification environment located in a process register information program, wherein the process register information program processes information from the special register to associate all specified-clock-group-related data packs with the specified clock group.

12. The computer-readable medium of claim 9, wherein the computer executable instructions for dereferencing the bit anonymous array to obtain specified bits are further configured to be performed in a register process module that is part of a register verification environment located in a process register information program, wherein the process register information program processes information from the special register to associate bits for every data pack of a specified clock group.

13. The computer-readable medium of claim 9, wherein the computer executable instructions are deployable to a client computer from a download server that is at a remote location.

14. The computer-readable medium of claim 9, wherein the computer executable instructions are provided by a download service provider to a client computer on an on-demand basis.
